(19) United States
(12) Patent Application Publication
(10) Pub. No.: US 2016/0210098 A1
(43) Pub. Date: Jul. 21, 2016

(54) SHORT RANGE SHARING OF E-READER CONTENT

(71) Applicant: Kobo Incorporated, Toronto (CA)

(72) Inventors: Benjamin LANDAU, Toronto (CA); Nora PARKER, Toronto (CA)

(73) Assignee: KOBO INCORPORATED, Toronto (CA)

(21) Appl. No.: 14/601,486

(22) Filed: Jan. 21, 2015

(51) Int. Cl. G06F 3/14; G09G 5/00; G06F 3/041

(52) U.S. Cl. CPC G06F 3/1423; G06F 3/0416; G09G 5/003; G09G 2330/021; G09G 2370/16

(57) ABSTRACT

Methods and systems for short range sharing of e-reader content are provided. A primary display having touch functionality is fixedly coupled with an e-reading device, the primary display for presenting an e-book thereon. In addition an e-book information provider is coupled with the e-reading device, the e-book information provider for presenting information about an e-book thereon.

### TECHNICAL FIELD

Examples described herein relate to short range sharing of e-reader content.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reading device) devices typically link to an online bookstore, and media playback devices often include applications that enable the user to access an online median electronic library (or e-Library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-Book services on a computing device, in an embodiment.

FIG. 2 illustrates an example architecture configuration of a computing device, according to an embodiment.

FIG. 3 illustrates a block diagram of a primary display and a secondary display on an e-reader, according to an embodiment.

FIG. 4 illustrates a method for short range sharing of e-reader content, according to an embodiment.

FIG. 5 illustrates an exemplary computer system according to an embodiment.

### DETAILED DESCRIPTION

Methods and systems for short range sharing of e-reader content are disclosed. Compared to print books, e-books allow for unprecedented privacy since title and cover are not visibly accessible. Conversely, this also makes it difficult for readers who may desire to share what they are currently reading. Such as, for example, to act as a conversation starter in a public place such as a coffee shop, public transport, classroom, or the like.

In one embodiment, the e-Reader device is equipped with a secondary, low-power EPD/e-ink display, oppositely-disposed to the primary display.

The secondary display enables readers to share their books with surrounding onlookers, based on appropriate sender/receiver permission settings. In general, onlookers near the reader can view the secondary display to get book ideas. Interested parties may also look up a reader's book from a distance using wireless communication to obtain the e-book information.

Thus, in one embodiment, e-book readers will be able to display the cover of the book they are currently reading via their device's secondary display located on the back surface of the device. If readers elect to enable this feature, they will also have the option to provide book information that can be accessed by other mobile device users via Wi Fi, Bluetooth, near field communication (NFC), or the like, as available via the product page on an e-book store, such as a pop-up window with synopsis, reviews, author information, and the option to buy or preview the text content.

In another embodiment, the reader can elect for the public access a predetermined title(s) from their library other than what they are reading such as for privacy reasons or the like. Yet another embodiment would allow the reader to elect display of one or more previously read books or a user definable number of highest-rated books they have read. In one embodiment, the information may be displayed on a timed cycle on their secondary display.

In one embodiment, short range sharing of e-reader content refers to a range of approximately 0-30 feet. For example, the short range sharing may be a visual reading distance. That is, the distance that one person can stand from a display screen and still read the information presented on the screen. In another example, the short range sharing may be a broadcast range of a Wi-Fi signal, Bluetooth signal, or the like. That is, the distance that a person holding a wireless signal receiver can stand away from a wireless signal generator and still receives the information being broadcast wirelessly.

In general, “E-Books” are a form of electronic publication content stored in digital format in a computer non-transitory memory, viewable on a computing device having display functionality. An e-Book can correspond to, or mimic, the paginated format of a printed publication for viewing, such as provided by printed literary works (e.g., novels) and periodicals (e.g., magazines, comic books, journals, etc.). Optionally, some e-Books may have chapter designations, as well as content that corresponds to graphics or images (e.g., such as in the case of magazines or comic books).

Multi-function devices, such as cellular-telephony or messaging devices, can utilize specialized applications (e.g., specialized e-reading application software) to view e-Books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-Book. By way of example, an e-reading device can include a mobile computing device on which an e-reading application can be executed to render content that includes e-Books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reading device, such as a purpose-built device that is optimized for an e-reading experience e.g., with E-displays).

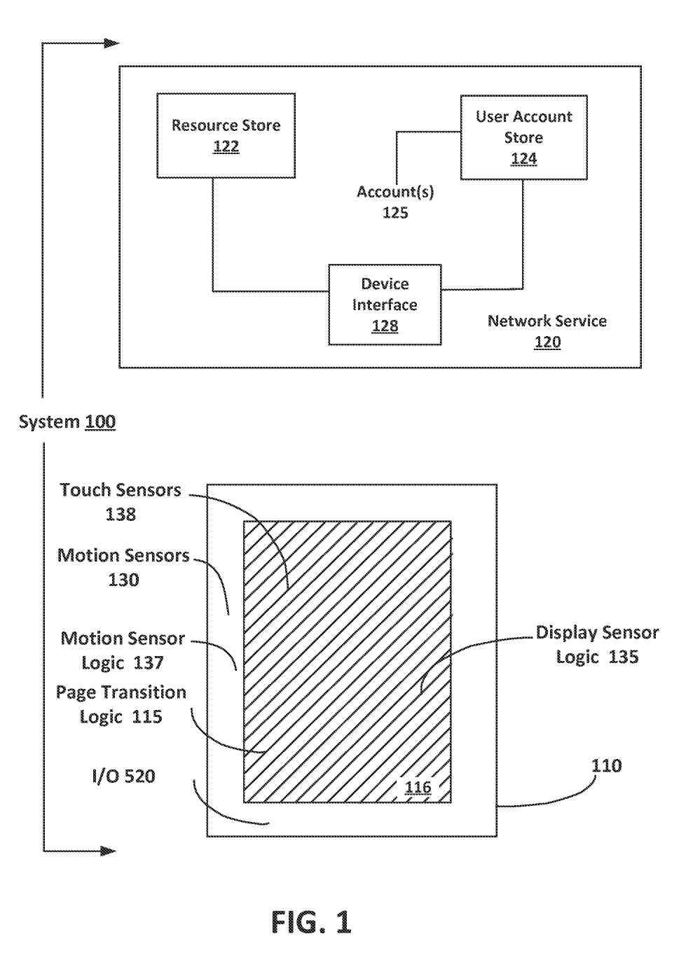

FIG. 1 illustrates a system 100 for utilizing applications and providing e-Book services on a computing device, according to an embodiment. In an example of Figure 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-Book services that communicate with the e-reading device 110. The e-Book services provided through network service 120 can, for example, include services in which e-Books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-Books, media files, documents) can be rendered and consumed. For example, the e-reading device 110 can correspond to a tablet or telephony/messaging device (e.g., smart phone). In one implementation, for example, e-reading device 110 can run an e-reading device application that links the device to the network service 120 and enables e-Books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-Books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-Books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-Books and content items are associated with the user device. Additionally, the device interface 128 can provide the e-reading device 110 with access to the resource store 122, which can include, for example, an online store. The device interface 128 can handle input to identify content items (e.g., e-Books), and further to link, content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the c-reading device 110 can store resources (e.g., e-Books) that are purchased or otherwise made available to the user of the e-reading device 110, as well as to archive e-Books and other digital content items that have been purchased for the user account 125, but are not stored on the particular computing device.

With reference to an example of FIG. 1, e-reading device 110 can include a display 116 and an optional housing, not shown. In an embodiment, the display 116 is touch-sensitive, to process touch inputs including gestures (e.g., swipes). For example, the display 116 may be integrated with one or more touch sensors 138 to provide a touch-sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display 116. Additionally, the housing can be integrated with touch sensors to provide one or more touch sensing regions, for example, on the bezel and/or back surface of the housing.

e-reading device 110 can also optionally include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

e-reading device 110 further includes motion sensor logic 137 to interpret user input motions as commands based on detection of the input motions by motion sensor(s) 130. For example, input motions performed on e-reading device 110 such as a tilt, a shake, a rotation, a swivel or partial rotation and an inversion may be detected via motion sensors 130 and interpreted as respective commands by motion sensor logic 137.

In some embodiments, the e-reading device 110 includes features for providing functionality related to displaying paginated content. The e-reading device 110 can include page transitioning logic 115, which enables the user to transition through paginated content. The e-reading device 110 can display pages from e-Books, and enable the user to transition from one page state to another. In particular, an e-Book can provide content that is rendered sequentially in pages, and the e-Book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-Book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116. Although discussed in context of “taps” herein, it is contemplated that a gesture action provided in sufficient proximity to touch sensors of display 116, without physically touching thereon, may also register as a “contact” with display 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display 116, otherwise known as a touch event. More specifically, display sensor logic 135 can detect a touch events also referred to herein as a tap, an initial tap held in contact with display 116 for longer than some pre-defined threshold duration of time (otherwise known as a “long press” or a “long touch”), multiple taps performed either sequentially or generally simultaneously, swiping gesture actions made through user interaction with the touch sensing region of the display 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held in sustained contact with display 116, during which sustained contact period the user or observer may take additional input actions, including gestures, on display 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of user gesture action so as to distinguish between, for example, leftward, rightward, upward, downward and diagonal swipes along a surface portion of display 116 for the purpose of associating respective input commands therewith.

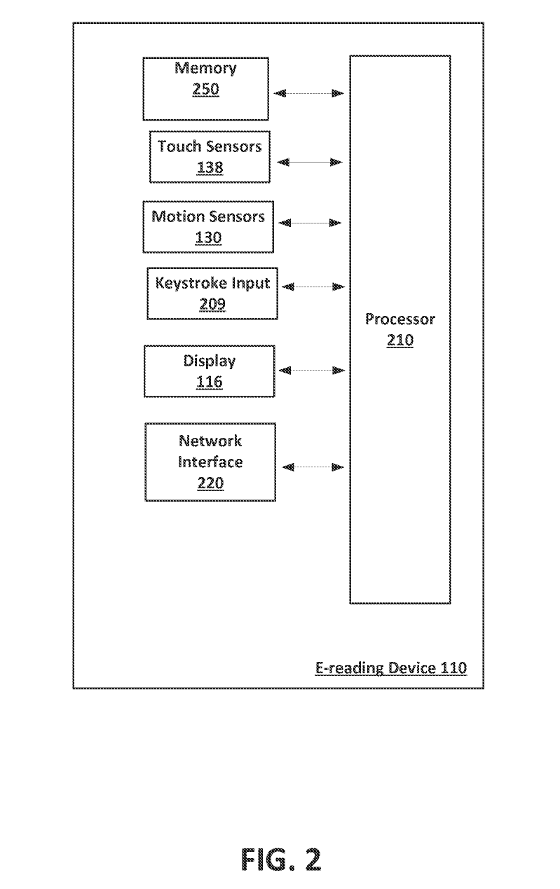

FIG. 2 illustrates further detail of e-reading device 110 as described above with respect to FIG. 1, in an embodiment. e-reading device 110 further includes processor 210, a memory 250 storing instructions and logic pertaining at least to display sensor logic 135, and page transition logic 115.

Processor 210 can implement functionality using the logic and instructions stored in memory 250. Additionally, in some implementations, processor 210 utilizes the network interface 220 to communicate with the network service 120 (see FIG. 1). More specifically, the e-reading device 110 can access the network service 120 to receive various kinds of resources (e.g., digital content items such as e-Books, configuration files, account information), as well as to provide information (e.g., user account information, service requests etc.). For example, e-reading device 110 can receive application resources, such as e-Books or media files, that the user elects to purchase or otherwise download via the network service 120. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can optionally receive input from various sources, including touch sensor components 138, display 116, keystroke input 209 such as from a virtual or rendered keyboard, and other input mechanisms (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-Book activities such as generating e-Book content on display 116, performing page transitions of the displayed e-Book content, powering off the e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

In one embodiment, network interface 220 of e-reading device 110 includes wireless connectivity subsystems, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of the wireless connectivity subsystem of network interface 220 depends on the communication network in which e-reading device 110 is intended to operate, such as in accordance with Wi-Fi, Bluetooth, Near Field Communication (NFC) communication protocols, and the like.

Display 116 of e-reading device 110 includes touch functionality whereby user input commands may be accomplished via gesture actions performed at display 116. In the context of reading digitally rendered pages comprising content of an e-Book, for example, some common input commands accomplished via gesture actions received at display 116 may include, for example, page turns, making annotations, adjusting illumination levels or contrast of the device display screen, and re-sizing the font size of text in the content.

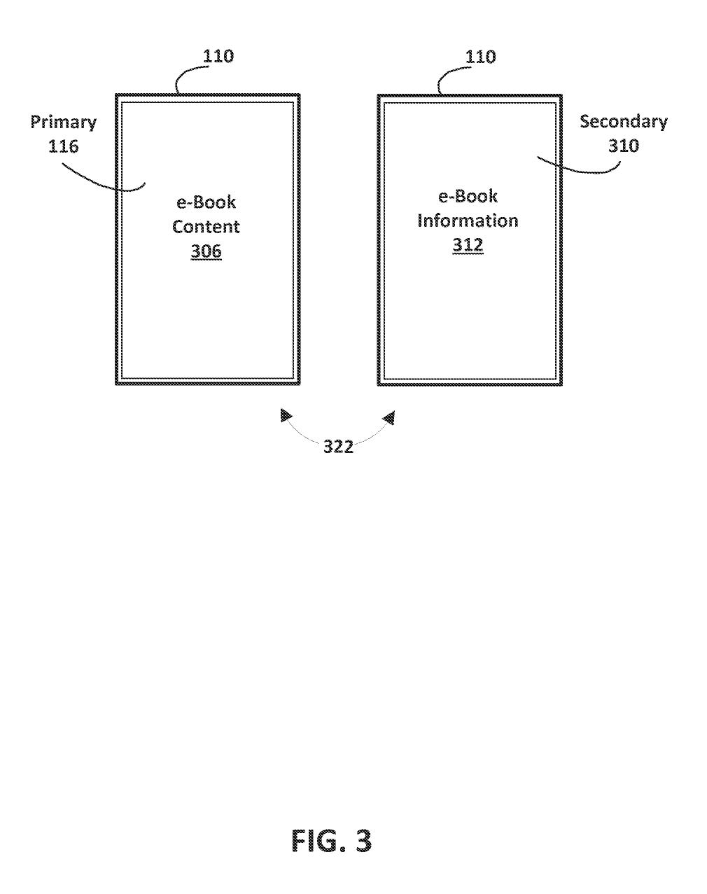

FIG. 3 illustrates a block diagram of an e-reading device 110 equipped with a primary display 116, and a secondary display 310.

In one embodiment, primary display 116 can correspond to, for example, a liquid crystal display (LCD) or light emitting diode (LED) display that illuminates in order to provide content generated from processor 210. In some implementations, primary display 116 can be touch-sensitive. For example, in some embodiments, one or more of the touch sensor components may be integrated with primary display 116. In other embodiments, the touch sensor components may be provided (e.g., as a layer) above or below primary display 116 such that individual touch sensor components track different regions of primary display 116.

Secondary display 310 can correspond to an electronic paper type display, such as an e-ink or bi-stable display that mimic conventional paper in the manner in which content is displayed. Typically, e-ink displays are more suited to e-reading under extreme ambient lighting conditions, such as very bright daylight or in near-darkness at bedtime, for long, immersive periods, resulting is less eye strain as compared to reading, for example, on an LCD display screen, Examples of such electronic paper display technologies include electrophoretic displays, electro-wetting displays, and electro-fluidic displays. Secondary display 310 can also be touch-sensitive; for example, in some embodiments, one or more of the touch sensor components may be integrated with secondary display 310, providing touch screen capability. Yet further, e-ink displays embodied in secondary display 117 consume relatively very minimal device battery power in comparison with, for example, an LCD display used in primary display screen 116. In some cases, e-ink displays consume computing device battery power at a less than 10 percent rate as compared to consumption of an LCD primary screen. For yet this additional reason, an e-ink screen as embodied in secondary display 310 would be very desirable for lengthy, immersive periods of reading e-book content via e-reading device 110.

As described herein, primary display 116 is used to present e-book 306 content to a user of the e-reading device 110 while secondary display 310 is used to present information about e-book 306 or other e-books to others that are not reading e-book 306 content. In one embodiment, secondary display 310 is a lower powered EPD/e-ink screen (than primary display 116) that is oppositely-disposed to the primary display 116 as shown by opposite side's arrow 322.

In another embodiment, secondary display 310 is fixedly coupled with a cover portion of the e-reading device 110 distinct from the primary display 116. For example, when the cover of the e-reader is opened, the primary display 116 will be facing the reader of e-book 306 while the secondary display 310 will be part of the e-reading device 110 cover that is facing onlookers and the like. For example, in one embodiment, the primary display 116 and the secondary display 310 are not concurrently visible from a same plane of view.

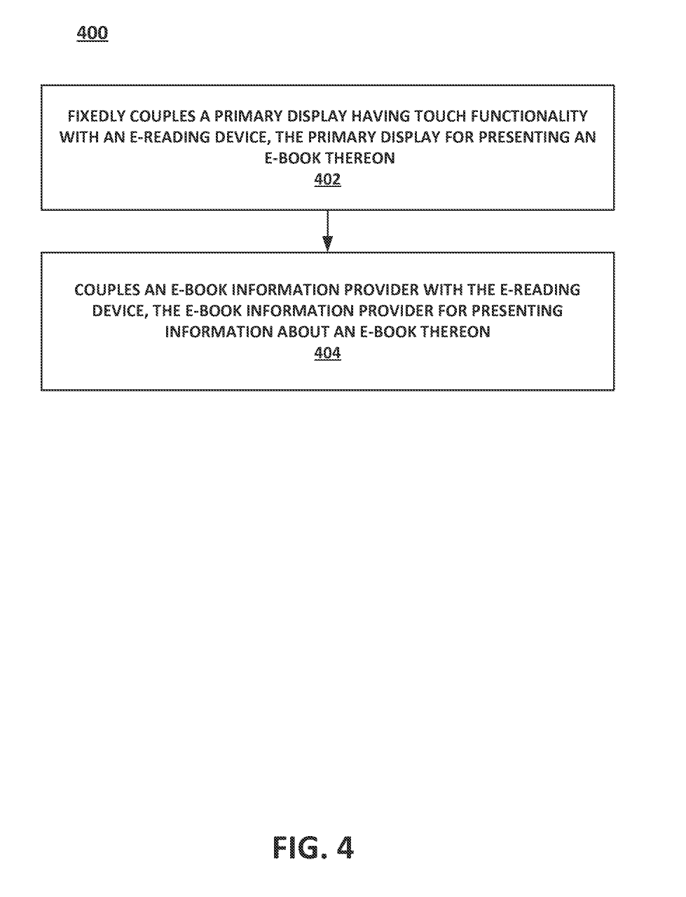

FIG. 4 illustrates a method 400 for short range sharing of e-reader content in accordance with one embodiment. In one embodiment, the method enables a reader to share their books with surrounding onlookers, based on appropriate sender/receiver permission settings, for example to create conversation starters in public places (coffee shops, public transport, etc.). Onlookers near the reader can get book ideas, or look up a reader's book from a distance using Wi Fi, Bluetooth, near field communication (NFC), or the like. Moreover, using the wireless broadcast will allow the onlooker to remember and even purchase the e-book without having to write the book title down.

Referring now to 402 of FIG. 1 and to FIG. 3, one embodiment fixedly couples primary display 116 having touch functionality with an e-reading device, the primary display 116 for presenting an e-book thereon.

With reference now to 404 of FIG. 4 and to FIGS. 1 and 3, one embodiment couples an e-book information provider with the e-reading device 110, the e-book information provider for presenting information 312 about an e-book thereon.

In one embodiment, the e-book information provider presents information 312 about the e-book 306 being presented on the primary display 116. For example, the e-book information provider may provide the title of the e-book, a picture of the cover of the e-book, a synopsis, a review, author information, an option to buy or preview the e-book, and the like.

In another embodiment, the e-book information provider presents information 312 about at least one e-book, wherein the information 312 does not include information about the e-book 306 being presented on the primary display 116. For example, an e-book user can elect the e-book information provider to present a predetermined title(s) from their library other than what they are reading such as for privacy reasons or if they want to seem more sophisticated.

Yet another embodiment allows the e-book user to authorize the e-book information provider to present a predefined number of previously read books, a predefined number of the user's highest-rated e-books they have read, and the like. In one embodiment, the information 312 may be presented at a timed cycle by the e-book information provider.

In one embodiment, the e-book information provider is a wireless broadcasting device such as network interface 220, such as, but not limited to, Wi-Fi, Bluetooth, near field communication (NFC), and the like.

However, in another embodiment, the e-book information provider is a secondary display 310 fixedly coupled with the e-reading device. For example, the secondary display 310 may be a low-power EPD/e-ink screen display wherein the power of the secondary display 310 is less than or equal to the power requirements of the primary display 116. In one embodiment, secondary display 310 does not have touch functionality.

In yet another embodiment, e-book information provider may utilize both the secondary display 310 and the wireless broadcasting device such as network interface 220.

In one embodiment, the primary display 116 and the secondary display 310 are not concurrently visible from a same plane of view. For example, in one embodiment, the primary display 116 is fixedly coupled with a first side of the e-reading device 110 and the secondary display 310 is fixedly coupled with a second side of the e-reading device 110 opposite of the primary display 116. That is, the primary display 116 is on the front of the e-reader and the secondary display 310 would be located on the back of the e-reader.

In another embodiment, the primary display 116 is fixedly coupled to a first side of the e-reading device and the secondary display 310 is fixedly coupled with a cover portion of the e-reader device distinct from the primary display 116. For example, the e-reader has a cover such that the cover must be opened for the primary display 116 to be seen. The secondary display 310 would be located on the cover such that when it is opened, the secondary display 310 is visible to other parties while the primary display 116 is visible to the e-book reader.

### Example Computer System Environment

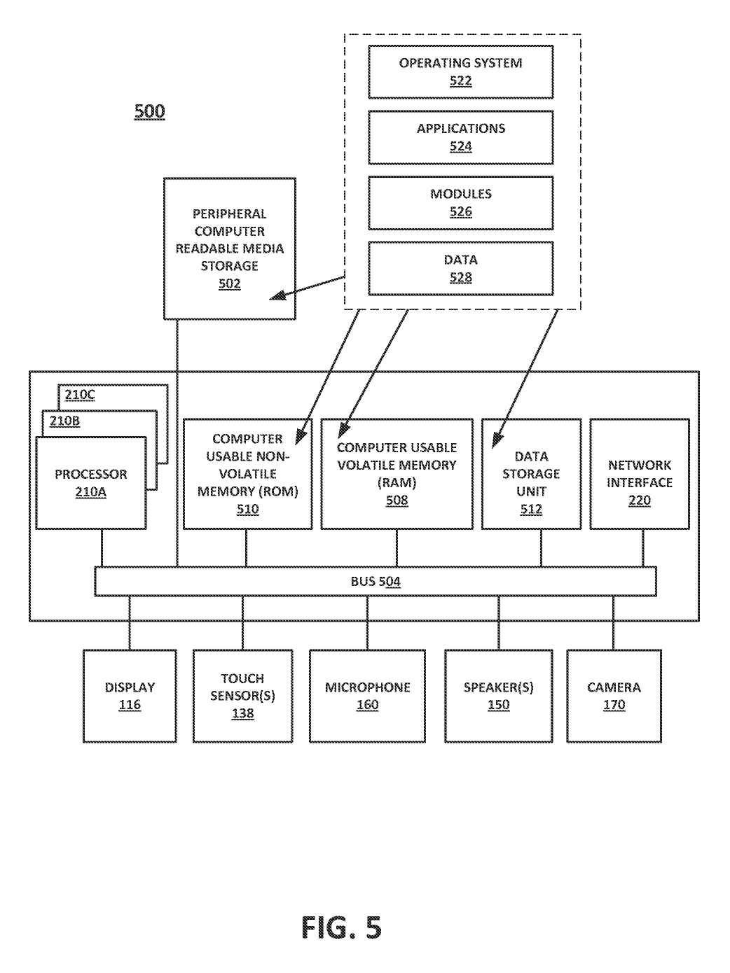

With reference now to FIG. 5, all or portions of some embodiments described herein are composed of computer-readable and computer-executable instructions that reside, for example, in computer-usable/computer-readable storage media of a computer system. That is, FIG. 5 illustrates one example of a type of computer system 500 that can be used in accordance with or to implement various embodiments of an e-reading device, such as e-reading device 110, which are discussed herein. It is appreciated that computer system 500 of FIG. 5 is only an example and that embodiments as described herein can operate on or within a number of different computer systems.

System 500 of FIG. 5 includes an address/data bus 504 for communicating information, and a processor 210A coupled to bus 504 for processing information and instructions. As depicted in FIG. 5, computer system 500 is also well suited to a multi-processor environment in which a plurality of processors 210A, 210B, and 210C are present. Processors 210A, 210B, and 210C may be any of various types of microprocessors. For example, in some multi-processor embodiments, one of the multiple processors may be a touch sensing processor and/or one of the processors may be a display processor. Conversely, computer system 500 is also well suited to having a single processor such as, for example, processor 210A.

System 500 also includes data storage features such as a computer usable volatile memory 508, e.g., random access memory (RAM), coupled to bus 504 for storing information and instructions for processors 210A, 210B, and 210C. System 500 also includes computer usable non-volatile memory 510, e.g., read only memory (ROM), coupled to bus 504 for storing static information and instructions for processors 210A, 210B, and 210C. Also present in computer system 500 is a data storage unit 512 (e.g., a magnetic or optical disk and disk drive) coupled to bus 504 for storing information and instructions.

Computer system 500 of FIG. 5 is well adapted to having peripheral computer-readable storage media 502 such as, for example, a floppy disk, a compact disc, digital versatile disc, universal serial bus “flash” drive, removable memory card, and the like coupled thereto. In some embodiments, computer-readable storage media 502 may be coupled with computer system 500 (e.g., to bus 504) by insertion into removable a storage media slot.

System 500 also includes or couples with display 116 for visibly displaying information such as alphanumeric text and graphic images. In some embodiments, computer system 500 also includes or couples with one or more optional touch sensors 138 for communicating information, cursor control, gesture input, command selection, and/or other user input to processor 210A or one or more of the processors in a multi-processor embodiment. In some embodiments, computer system 500 also includes or couples with one or more optional speakers 150 for emitting audio output. In some embodiments, computer system 500 also includes or couples with an optional microphone 160 for receiving/capturing audio inputs. In some embodiments, computer system 500 also includes or couples with an optional digital camera 170 for receiving/capturing digital images as an input.

Optional touch sensor(s) 138 allows a user of computer system 500 (e.g., a user of an e-reader of which computer system 500 is a part) to dynamically signal the movement of a visible symbol (cursor) on display 116 and indicate user selections of selectable items displayed. In some embodiment other implementations of a cursor control device and/or user input device may also be included to provide input to computer system 500, a variety of these are well known and include: trackballs, keypads, directional keys, and the like.

System 500 is also well suited to having a cursor directed or user input received by other means such as, for example, voice commands received via microphone 160. System 500 also includes a network interface 220 for coupling computer system 500 with external entities. For example, in one embodiment, network interface 220 is a modem for enabling wired communications or modem and radio for enabling wireless communications between computer system 500 and an external device and/or external network such as, but not limited to, the Internet. network interface 220 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 5, various other components are depicted for computer system 500. Specifically, when present, an operating system 522, applications 524, modules 526, and/or data 528 are shown as typically residing in one or some combination of computer usable volatile memory 508 (e.g., RAM), computer usable non-volatile memory 510 (e.g., ROM), and data storage unit 512. For example, modules 526 may include an application module for providing an image based decision platform for a user.

In some embodiments, all or portions of various embodiments described herein are stored, for example, as an application 524 and/or module 526 in memory locations within RAM 508, ROM 510, computer-readable storage media within data storage unit 512, peripheral computer-readable storage media 502, and/or other tangible computer readable storage media.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A system for short range sharing of e-reader content comprising:
a primary display of an e-reading device for presenting an e-book thereon; and
a secondary display coupled with the e-reading device for presenting information about the e-book thereon, wherein the primary display and the secondary display are not concurrently visible from a same plane of view.

2. The system of claim 1 wherein the primary display comprises a touch functionality.

3. The system of claim 1 wherein the secondary display is a lower power display than the primary display and does not have touch functionality.

4. The system of claim 1 wherein the primary display is fixedly coupled with a first side of the e-reading device and the secondary display is fixedly coupled with a second side of the e-reader device opposite of the primary display.

5. The system of claim 1 wherein the primary display is fixedly coupled to a first side of the e-reading device and the secondary display is fixedly coupled with a cover portion of the e-reader device distinct from the primary display.

6. The system of claim 1 wherein the secondary display presents information about the e-book being presented on the primary display.

7. The system of claim 1 wherein the secondary display presents information about at least one e-book, wherein the information does not include information about the e-book being presented on the primary display.

8. A system for short range sharing of e-reader content comprising:
a memory that stores a set of instructions;
a processor that access the set of instructions in the memory;
a primary display of an e-reading device having touch functionality, the primary display for presenting an e-hook thereon; and
an e-book information provider coupled with the e-reading device for presenting information about an e-book thereon.

9. The system of claim 8 wherein the e-book information provider is a wireless broadcasting device.

10. The system of claim 8 wherein the e-book information provider is a secondary display fixedly coupled with the e-reading device.

11. The system of claim 10 wherein the primary display is fixedly coupled with a first side of the e-reading device and the secondary display is fixedly coupled with a second side of the e-reader device opposite of the primary display, wherein the primary display and the secondary display are not concurrently visible from a same plane of view.

12. The system of claim 10 wherein the primary display is fixedly coupled to a first side of the e-reading device and the secondary display is fixedly coupled with a cover portion of the e-reader device distinct from the primary display.

13. The system of claim 8 wherein the e-book information provider presents information about the e-book being presented on the primary display.

14. The system of claim 8 wherein the e-book information provider presents information about at least one e-book, wherein the information does not include information about the e-book being presented on the primary display.

15. A non-transitory computer implemented method for short range sharing of e-reader content, said method comprising:
fixedly coupling a primary display having touch functionality with an e-reading device, the (primary display for presenting an e-book thereon; and
coupling an e-book information provider with the e-reading device, the e-book information provider for presenting information about an e-book thereon.

16. The non-transitory computer implemented method of claim 15 further comprising:
utilizing a wireless broadcasting device as the e-book information provider.

17. The non-transitory computer implemented method of claim 15 further comprising:
utilizing a secondary display fixedly coupled with the e-reading device as the e-book information provider.

18. The non-transitory computer implemented method of claim 17 further comprising:
fixedly coupling the primary display with a front facing side of the e-reading device; and
fixedly coupling the secondary display with a back facing side of the e-reader device.

19. The non-transitory computer implemented method of claim 17 further comprising:
fixedly coupling the primary display with a first side of the e-reading device; and
fixedly coupling the secondary display with a cover portion of the e-reader device.

20. The non-transitory computer implemented method of claim 15 further comprising:
utilizing the e-book information provider to provide information about the e-book being presented on the primary display.

21. The non-transitory computer implemented method of claim 15 further comprising:
utilizing the e-book information provider to provide information about at least one e-book, wherein the information does not include information about the e-book being presented on the primary display.
